(19) United States
(12) Patent Application Publication
(10) Pub. No.: US 2008/0252285 A1
(43) Pub. Date: Oct. 16, 2008

(54) Machine with a rotary position-sensing system

(75) Inventors: Shawn C. Passwater, Metamora, IL (US); Daniel Ross Ekstrand, Peoria, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/711,789

(22) Filed: Feb. 28, 2007

(51) Int. Cl. G01B 7/30; H02P 7/06

(52) U.S. Cl. 324/207.25

(57) ABSTRACT

A machine includes a first component and a second component between which relative rotation can occur about a rotation axis. The machine may also include a rotary position-sensing system, which may include a plurality of magnets mounted to the first component. The plurality of magnets mounted to the first component may include a first magnet and a second magnet mounted to the first component at different angular positions around the rotation axis. The first magnet may be magnetized in a first direction that is at an angle to a circle that extends through the first magnet perpendicular and concentric to the rotation axis. The rotary position-sensing system may also include a magnetic-flux sensor mounted to the second component to sense magnetic flux generated by at least one of the first magnet and the second magnet and generate a signal.

### TECHNICAL FIELD

The present disclosure relates to machines with a rotary position-sensing system for sensing the rotary position of a component and, more particularly, to machines with a rotary position-sensing system that uses at least one magnet to sense the rotary position of a component.

### BACKGROUND

Many machines include one or more rotating components. Some such machines include a rotary position-sensing system that senses the rotary position of a rotating component. Some rotary position-sensing systems include a single magnet attached to a rotating component and a magnetic-flux sensor adjacent the rotating component to sense magnetic flux generated by the magnet. In such rotary position-sensing systems, the position of the magnet relative to the magnetic-flux sensor, and thus the strength of the magnetic field at the magnetic-flux sensor, may vary as a function of the rotational position of the rotating component. Accordingly, by generating a signal related to the density of magnetic flux sensed by the magnetic-flux sensor, the rotary position-sensing system may provide information about the rotational position of the rotating component.

In a rotary position-sensing system that includes a magnetic-flux sensor and a single magnet mounted to the rotating component, the strength of the magnetic field at the magnetic-flux sensor may change in a relatively gradual manner as the rotary position of the rotating component changes. Unfortunately, this may negatively impact the precision of the rotary position-sensing system by making the sensitivity of the rotary position-sensing system to the position of the rotating component relatively low compared to its sensitivity to spurious factors like manufacturing tolerances and variations in operating conditions.

U.S. Pat. No. 6,498,480 to Manara (“the '480 patent”) discloses a machine with a rotary position-sensing system that uses a hall-effect device mounted to a platform to sense magnetic flux from two magnets mounted to a rotating component adjacent the platform. In the machine disclosed by the '480 patent, the two magnets mount to the rotating component at a distance from an axis that the rotating component rotates around, such that the magnets travel along a circular path when the rotating component rotates around the axis. Each of the magnets is magnetized in a direction tangential to this circular path. The hall-effect device of the rotary position-sensing system shown by the '480 patent sits on this circular path between the two magnets.

Although the rotary position-sensing system of the '480 patent senses magnetic flux from two magnets mounted to the rotating component, certain disadvantages persist. For example, the arrangement of the magnets and the hall-effect device disclosed in the '480 patent causes the density of the magnetic flux at the hall-effect device to vary in a relatively gradual manner as the rotational position of the rotating component changes. For the reason mentioned above in connection with single-magnet rotary position-sensing systems, this operating characteristic may tend to negatively impact how precisely the rotary position-sensing system indicates the position of the rotating component. Additionally, by sitting on the circular path that the two magnets traverse during rotation of the rotating component, the hall-effect device of the '480 patent may limit the range of rotation of the rotating component to an undesirable extent for some applications.

The rotary position-sensing system and methods of the present disclosure solve one or more of the problems set forth above.

### SUMMARY OF THE INVENTION

One disclosed embodiment relates to a machine that includes a first component and a second component between which relative rotation can occur about a rotation axis. The machine may also include a rotary position-sensing system, which may include a plurality of magnets mounted to the first component. The plurality of magnets mounted to the first component may include a first magnet and a second magnet mounted to the first component at different angular positions around the rotation axis. The first magnet may be magnetized in a first direction that is at an angle to a circle that extends through the first magnet perpendicular and concentric to the rotation axis. The rotary position-sensing system may also include a magnetic-flux sensor mounted to the second component to sense magnetic flux generated by at least one of the first magnet and the second magnet and generate a signal.

Another embodiment relates to a method of operating a machine having a first component and a second component between which relative rotation may occur about a rotation axis. The method may include generating magnetic flux with a first magnet mounted to the first component. The method may also include generating magnetic flux with a second magnet mounted to the first component at different angular position around the rotation axis than the first magnet. Additionally, the method may include sensing magnetic flux generated by the first magnet and the second magnet with a magnetic-flux sensor mounted to the second component. The method may also include selectively generating relative rotation between the first component and the second component about the rotation axis, including selectively generating relative rotation between the first component and the second component through a range wherein at least one of the magnets and the magnetic-flux sensor pass one another.

### BRIEF DESCRIPTION OF THE DRAWINGS

FIG. 1A is a schematic illustration of a machine and a rotary position-sensing system according to the present disclosure;

FIG. 1B is a sectional view through line 1B-1B of FIG. 1A;

FIG. 1C is a sectional view through line 1C-1C of FIG. 1A;

FIG. 2 is a schematic illustration of another embodiment of a machine according to the present disclosure;

FIG. 3A is a schematic illustration of the machine and rotary position-sensing system shown in FIG. 1A with magnetic flux shown in dotted lines;

FIG. 3B is a schematic illustration of the machine and rotary position-sensing system shown in FIG. 3A with the components thereof in different relative positions;

FIG. 3C is a schematic illustration of the machine and rotary position-sensing system shown in FIG. 3B with the components thereof in different relative positions; and

FIG. 4 graphically illustrates how magnetic-flux density at a magnetic-flux sensor varies as a function of relative rotary position between two components for one embodiment according to the present disclosure.

### DETAILED DESCRIPTION

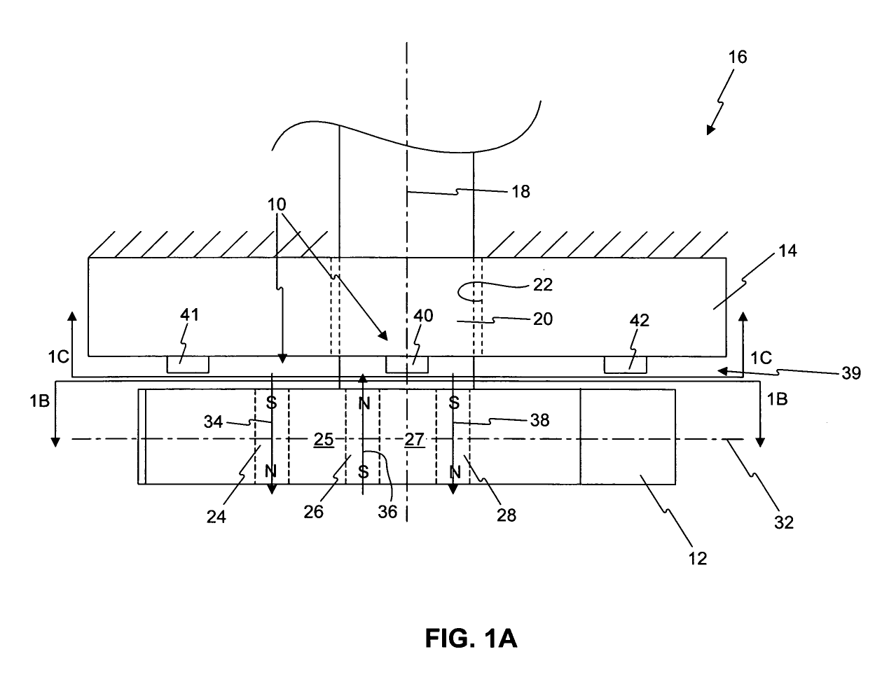

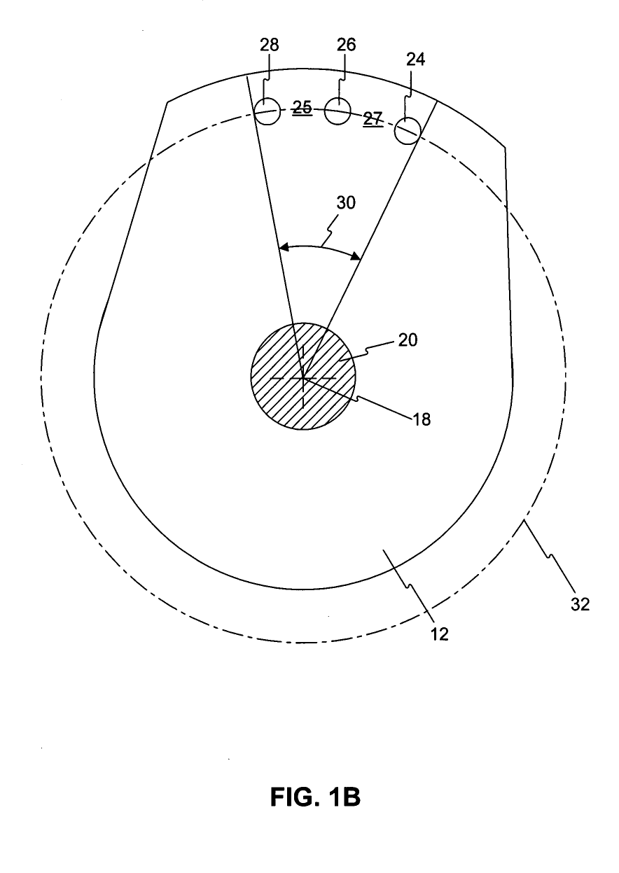

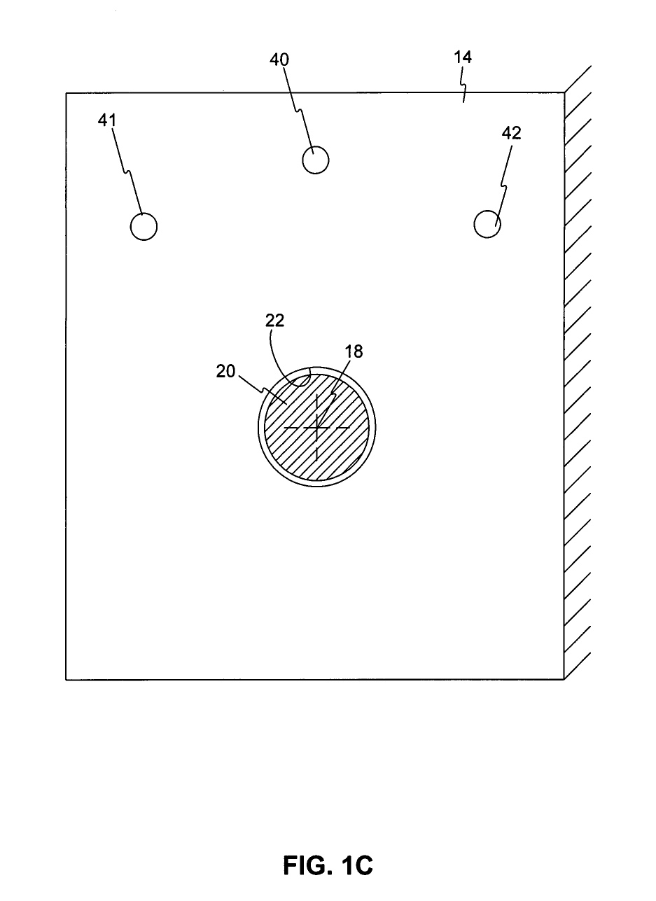

FIGS. 1A-1C illustrate one embodiment of a rotary position-sensing system 10 according to the present disclosure employed to sense the angular relationship between a component 12 and a component 14 of a machine 16. Components 12, 14 may be any components between which relative rotation may occur about a rotation axis 18. Machine 16 may have various provisions for constraining movement of components 12, 14. As indicated in FIGS. 1A and 1C, machine 16 may hold component 14 in a fixed position. Additionally, component 12 may have a shaft 20 engaging a bore 22 extending along rotation axis 18 through component 14, thereby limiting rotation of component 12 to rotation around rotation axis 18.

The configurations of components 12, 14 and the provisions for constraining their motion are not limited to the example provided in FIGS. 1A-1C. For example, machine 16 may hold component 12 stationary and allow component 14 to rotate around rotation axis 18. Similarly, machine 16 may allow components 12, 14 to both rotate around rotation axis 18 at different speeds and/or in different directions. Additionally, machine 16 may constrain relative movement between components 12, 14 without physical engagement between components 12, 14.

Rotary position-sensing system 10 may include magnets 24, 26, 28 mounted to component 12. As FIG. 1B shows, magnets 24, 26, 28 may mount to component 12 at different angular positions around rotation axis 18. Magnets 24, 26, 28 may have spaces 25 and 27 between them. Additionally, magnets 24, 26, 28 may be nonuniformly distributed around rotation axis 18. For example, as FIG. 1B shows, magnets 24, 26, 28 may mount to component 12 in a group that occupies a relatively small angular segment 30 of component 12. In some embodiments, magnets 24, 26, 28 may all sit the same distance from rotation axis 18 with a circle 32 that extends perpendicular and concentric to rotation axis 18 extending through magnets 24, 26, 28. In embodiments like the one shown in FIGS. 1A-1C, where component 12 can rotate around rotation axis 18, circle 32 may constitute the path of travel of magnets 24, 26, 28 during relative rotation between components 12, 14 about rotation axis 18.

Rotary position-sensing system 10 may have one or more of magnets 24, 26, 28 magnetized in different directions. For example, as FIG. 1A shows, magnet 26 may be magnetized in a magnetization direction 36, and magnets 24, 28 may be magnetized in magnetization directions 34, 38 oriented generally opposite magnetization direction 36. Magnetization direction 36 may extend generally toward an interface 39 between components 12, 14, and magnetization directions 34, 38 may extend generally away from interface 39.

In some embodiments, magnetization directions 34, 36, 38 may extend at an angle to circle 32. For example, as FIG. 1A shows, magnetization directions 34, 36, 38 may all extend substantially parallel to rotation axis 18. Alternatively, one or more of magnetization directions 34, 36, 38 may extend at some other angle with respect to circle 32, such as radially toward or away from rotation axis 18.

Rotary position-sensing system 10 may also include magnetic-flux sensors 40, 41, 42 mounted to component 14 at interface 39 to sense magnetic flux generated by magnets 24, 26, 28. Each magnetic-flux sensor 40, 41, 42 may include any type of component configured to generate a signal related to the quantity of magnetic flux flowing through it. For example, each magnetic-flux sensor 40, 41, 42 may include a hall-effect device. Additionally, each magnetic-flux sensor 40, 41, 42 may include information-processing circuitry for processing the output of the hall-effect device.

In some embodiments, the configuration of machine 16 and the positioning of magnetic-flux sensors 40, 41, 42 may allow at least one of magnets 24, 26, 28 and at least one of magnetic-flux sensors 40, 41, 42 to pass one another during relative rotation between components 12, 14 about rotation axis 18. Magnetic-flux sensors 40, 41, 42 may mount to component 14 adjacent circle 32. Additionally, the configuration of machine 16 may allow component 12 to rotate through a sufficiently large range about rotation axis 18 to allow magnets 24, 26, 28 to pass each of magnetic-flux sensors 40, 41, 42. Of course, in embodiments where component 14 can rotate around rotation axis 18, machine 16 may similarly have a configuration that allows magnetic-flux sensors 40, 41, 42 to sweep past magnets 24, 26, 28.

Rotary position-sensing system 10 is not limited to the configuration shown in FIGS. 1A-1C. For example, rotary position-sensing system 10 may have the magnetization directions 34, 36, 38 of magnets 24, 26, 28 oriented differently than shown in FIGS. 1A and 1B. In some embodiments, magnetization direction 36 may extend generally away from interface 39, and magnetization directions 34, 38 may extend generally toward interface 39. Additionally, rotary position-sensing system 10 may have one or more of magnets 24, 26, 28 and magnetic-flux sensors 40, 41, 42 mounted in different positions than shown in FIGS. 1A-1C. Furthermore, rotary position-sensing system 10 may omit one of magnets 24, 26, 28 and/or include additional magnets mounted to component 12. Similarly, rotary position-sensing system 10 may include one or more additional magnetic-flux sensors.

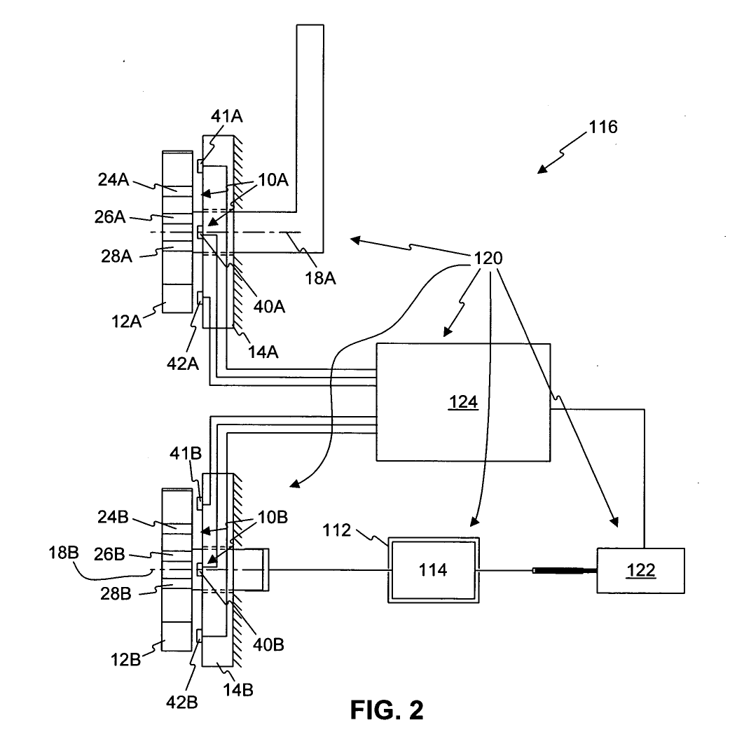

FIG. 2 shows another embodiment of a machine 116 according to the present disclosure. Machine 116 may include components 12A, 14A between which relative rotation may occur about a rotation axis 18A. The configurations of components 12A, 14A and the manner in which they interact with one another and other components of machine 116 may be generally the same as the configurations of components 12, 14 and the manner in which they interact with one another and other components of machine 10. In some embodiments, component 12A may be an operator input member, such as a handle or a pedal, that an operator of machine 116 rotates around rotation axis 18A to indicate one or more aspects of how the operator desires machine 116 to operate. For example, component 12A may be a gearshift handle that an operator rotates around rotation axis 18A to indicate which of multiple possible modes the operator desires a transmission (not shown) of machine 116 to operate in.

Machine 116 may also include components 12B, 14B between which relative rotation may occur about a rotation axis 18B. The configurations of components 12B, 14B and the manner in which they interact with one another and other components of machine 116 may be generally the same as the configurations of components 12, 14 and the manner in which they interact with one another and other components of machine 10. Component 12B may connect to a control component 114. Control component 114 may be, for example, a valve member of a control valve 112. Control valve 112 may be, for example, a control valve of a transmission (not shown) of machine 116.

Machine 116 may also include a rotary position-sensing systems 10A, 10B. Like rotary position sensing-system 10, rotary position-sensing system 10A may include a plurality of magnets 24A, 26A, 28A mounted to component 12A, and magnetic-flux sensors 40A, 41A, 42A mounted to component 14A. Similarly, rotary position-sensing system 10B may include a plurality of magnets 24B, 26B, 28B mounted to component 12B, and magnetic-flux sensors 40B, 41B, 42B mounted to component 14B. Each rotary position-sensing system 10A, 10B and the components thereof may have generally the same configuration as rotary position-sensing system 10 and the components thereof.

Components 12A, 14A, 12B, 14B, rotary position-sensing systems 10A, 10B, and control component 114 may all form part of a control system 120 of machine 116. In addition to these items, control system 120 may include any other components that control one or more aspects of the operation of machine 116. In some embodiments, control system 120 may include an actuator 122. Actuator 122 may be any type of device operable when activated to rotate control component 114 and component 12B around axis 18B, including, but not limited to an electric motor, a pneumatic actuator, or a hydraulic actuator. Control system 120 may also include a controller 124 operable to control the activity of actuator 122. Controller 124 may include one or more processors (not shown) and one or more memory devices (not shown). Controller 124 may be communicatively linked to each magnetic-flux sensor 40A, 41A, 42A, 40B, 41B, 42B of rotary position-sensing systems 10A, 10B. Controller 124 may also be communicatively linked to various other sources of information about operation of machine 116, such as other sensors and/or controllers.

Machine 116 is not limited to the configuration shown in FIG. 2 and discussed above. For example, component 12A may serve a purpose other than an acting as an operator-input member. Additionally, actuator 122 may connect to control component 114 and component 12B in different ways than shown in FIG. 2, such as through various types of power-transfer components. Furthermore, component 12B may connect to a component other than control component 114. Moreover, machine 116 may hold component 12A stationary, and allow component 14A to rotate around rotation axis 18A. In such embodiments, component 14A, rather than component 12A may serve as an operator-input member, such as a handle or a pedal. Similarly, machine 116 may hold component 12B stationary and allow component 14B to rotate around rotation axis 18B. In such embodiments, component 14B, rather than component 12B, may connect to control component 114 and actuator 122. Furthermore, in addition to, or in place of, controller 124, control system 122 may include one or more other types of control components that receive inputs from rotary position-sensing systems 10A, 10B and participate in control of actuator 122.

### INDUSTRIAL APPLICABILITY

Machines 16, 116 may have use in any application requiring relative rotation between two components and rotary position-sensing systems 10, 10A, 10B may have use in any application requiring information about the relative rotary positions of two components. During operation of machine 116, torque applied to component 12A by an operator may generate relative rotation between components 12A, 14A, which may include relative rotation through one or more ranges wherein at least one of magnets 24A, 26A, 28A and at least one of magnetic-flux sensors 40A-42A pass one another. Similarly, torque applied to control component 114 and component 12B by actuator 122 may generate relative rotation between components 12B, 14B, which may include relative rotation through one or more ranges wherein at least one of magnets 24B, 26B, 28B and at least one of magnetic-flux sensors 40B-42B pass one another.

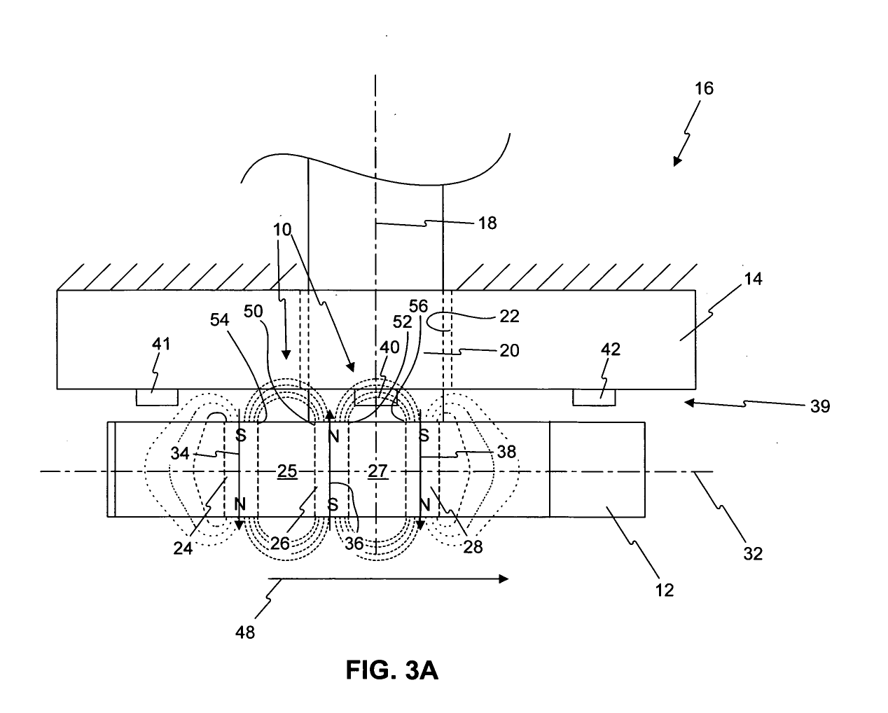

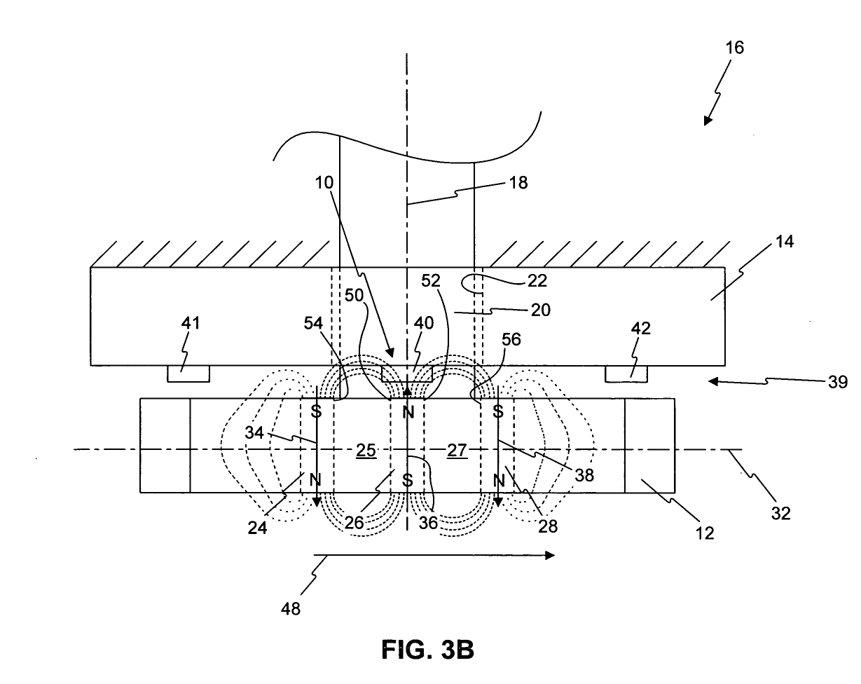

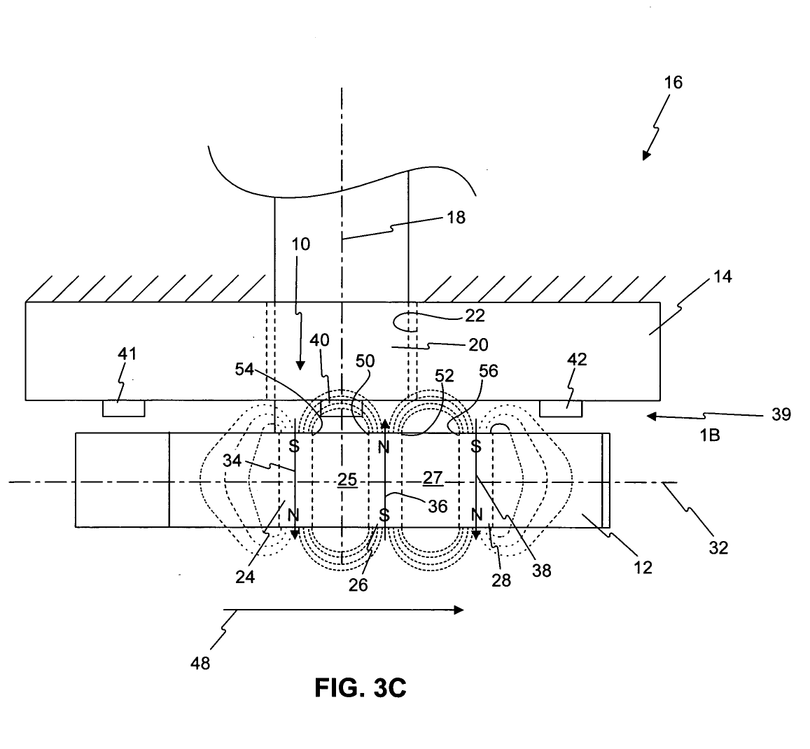

Similarly, during operation of machine 16, torque applied to component 12 and/or component 14 by other components of machine 16 and/or an operator may generate relative rotation between components 12, 14. This may include rotating component 12 and/or component 14 through one or more ranges of rotary positions within which at least a portion of at least one of magnets 24, 26, 28 and at least one of magnetic-flux sensors 40, 41, 42 pass one another. For example, from the position shown in FIG. 3A, component 12 may rotate in a direction 48, through the position shown in FIG. 3B, to the position shown in FIG. 3C. During such motion, magnet 26 may pass magnetic-flux sensor 40, and the magnetization directions 34, 36, 38 of each of magnets 24, 26, 28 may sweep through magnetic-flux sensor 40.

In each of FIGS. 3A-3C, dotted lines illustrate magnetic flux generated by magnets 24, 26, 28. As FIGS. 3A-3C show, the density of magnetic flux in interface 39 varies in circumferential directions. With the magnetization directions 34, 36, 38 of adjacent magnets 24, 26, 28 oriented in generally opposite directions, most of the magnetic flux in the area between magnets 24, 26, 28 may flow in relatively concentrated patterns between the poles of magnet 26 and the poles of magnets 24, 28. This may result in large magnetic-flux gradients in directions transverse to magnetization direction 36 at outer edges 50, 52 of magnet 26. Additionally, orienting magnetization direction 36 at an angle to circle 32 may ensure that these large magnetic-flux gradients at outer edges 50, 52 of magnet 26 extend at least partially circumferentially. This may result in large magnetic-flux gradients in circumferential directions at positions in interface 39 adjacent outer edges 50, 52 of magnet 26. For similar reasons, large magnetic-flux gradients in circumferential directions may also occur at positions in interface 39 adjacent inner edges 54, 56 of magnets 24, 28, respectively.

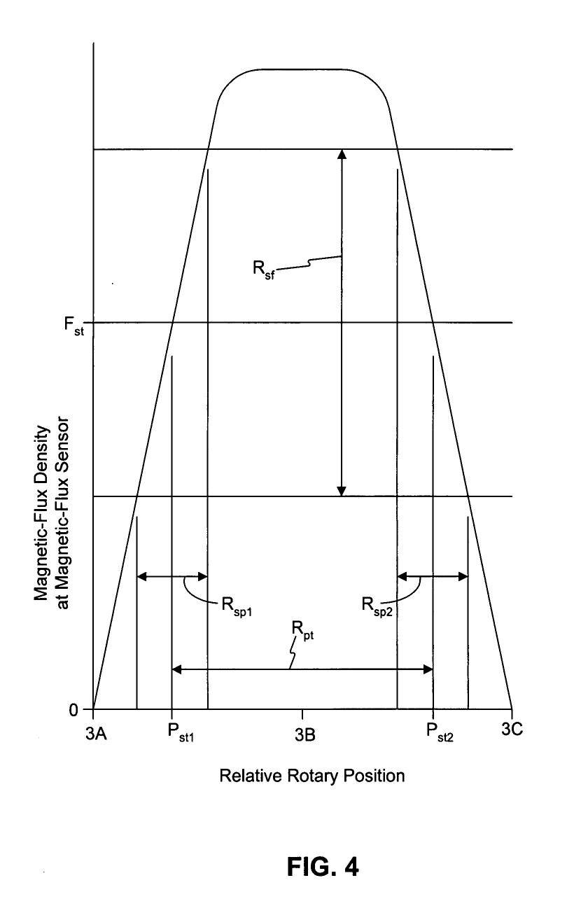

Because the density of magnetic flux in interface 39 varies in circumferential directions, the density of magnetic flux at magnetic-flux sensor 40 may vary as a function of the relative rotary positions of components 12, 14. FIG. 4 graphically illustrates how the magnetic-flux density at magnetic-flux sensor 40 may vary as the rotary position of component 12 varies between the position shown in FIG. 3A and the position shown in FIG. 3C. Along the abscissa in FIG. 4, the reference characters 3A, 3B, and 3C indicate the positions shown in FIGS. 3A, 3B, and 3C, respectively.

With component 12 in position 3A, approximately zero magnetic flux may flow through magnetic-flux sensor 40. As component 12 moves from position 3A in direction 48, the large magnetic-flux gradient in interface 39 adjacent outer edge 52 of magnet 26 may cross magnetic-flux sensor 40, and the magnetic-flux density at magnetic-flux sensor 40 may rise rapidly. Once outer edge 52 of magnet 26 has passed magnetic-flux sensor 40, the density of magnetic flux at magnetic-flux sensor 40 may continue rising in a more gradual fashion until the center of magnet 26 aligns with the center of magnetic-flux sensor 40 at position 3B. Subsequently, as component 12 continues rotating in direction 48 and magnet 26 moves away from magnetic-flux sensor 40, the magnetic-flux density through magnetic-flux sensor 40 may drop in a pattern substantially opposite the pattern in which it increased while magnet 26 approached position 3B.

Magnetic-flux sensor 40 may generate a signal based on the quantity of magnetic flux flowing through it, which signal may provide information about the relative rotary position of components 12, 14. In some embodiments, magnetic-flux sensor 40 may generate a binary signal for the purpose of indicating whether the relative rotary position of components 12, 14 falls within a target range of positions, such as range Rₚₜ shown in FIG. 4. The magnetic-flux sensor 40 may accomplish this purpose by causing the binary signal to have one value whenever the relative rotary position of components 12, 14 falls within range Rₚₜ and another value whenever the relative rotary position of components 12, 14 falls outside of range Rₚₜ. This would entail the magnetic-flux sensor 40 switching the value of the binary signal whenever the relative rotary position of components 12, 14 crosses either a first target-switching position Pₛₜ₁ or a second target-switching position Pₛₜ₂ disposed at opposite ends of range Rₚₜ. The magnetic-flux sensor 40 may have a configuration designed to cause it to achieve this result by always switching the value of the binary signal at a target-switching-flux Fₛₜ corresponding to target-switching positions Pₛₜ₁, Pₛₜ₂.

Various relative rotary positions of components 12, 14 may constitute target-switching positions Pₛₜ₁, Pₛₜ₂. In some embodiments, a relative rotary position of components 12, 14 where the center of magnetic-flux sensor 40 aligns with the large circumferential magnetic-flux gradient adjacent outer edge 52 of magnet 26, may constitute first target-switching position Pₛₜ₁. Similarly, a relative rotary position of components 12, 14 where the center of magnetic-flux sensor 40 aligns with the large circumferential magnetic-flux gradient adjacent outer edge 50 of magnet 26 may constitute second target-switching position Pₛₜ₂.

In practice, various factors may cause magnetic-flux sensor 40 to switch the value of the binary signal in response to a magnetic-flux density greater or less than its target-switching-flux Fₛₜ. For example, factors such as manufacturing tolerances, component wear, and varying operating conditions may cause magnetic-flux sensor 40 to switch the value of the binary signal at any value of magnetic flux within a switching-flux range R_{sf} shown in FIG. 4. Accordingly, magnetic-flux sensor 40 may switch the value of the binary signal at any relative rotary position of components 12, 14 within either of a first switching position range Rₛₚ₁ and a second switching position range Rₛₚ₂, surrounding target-switching positions Pₛₜ₁, Pₛₜ₂.

The disclosed configurations may advantageously allow rotary position-sensing system 10 to indicate in a highly precise manner when the relative rotary position of components 12, 14 crosses into or out of target position range Rₚₜ. Providing large circumferential magnetic-flux gradients at target-switching positions Pₛₜ₁, Pₛₜ₂ may ensure relatively small switching position ranges Rₛₚ₁ Rₛₚ₂, even if magnetic-flux sensor 40 has a relatively large switching-flux range R_{sf}.

The above-described operating characteristics may also apply when components 12, 14 have relative rotary positions that put magnet 26 close to magnetic-flux sensor 41 or magnetic-flux sensor 42. For example, for positions of magnet 26 close to magnetic-flux sensor 41 or magnetic-flux sensor 42, the density of magnetic flux at that magnetic-flux sensor 41, 42 may vary as a function of the relative rotary position of components 12, 14 in substantially the same pattern as shown in FIG. 4. Additionally, magnetic-flux sensors 41, 42 may respond to magnetic flux from magnets 24, 26, 28 in substantially the same manner as magnetic-flux sensor 40.

Operation of machine 16 and rotary position-sensing system 10 is not limited to the examples provided above. For example, components 12, 14 may undergo relative rotation around rotation axis 18 other than that discussed above, such as rotation of component 12 through different ranges, rotation of component 12 in a direction opposite direction 48, and/or rotation of component 14 around rotation axis 18. Additionally, in some embodiments, in addition to, or in place of, a binary signal, magnetic-flux sensors 40, 41, 42 may generate another type of signal based on the quantity of magnetic flux flowing through them. In such embodiments, the large circumferential magnetic-flux gradients at certain locations around interface 39 may still enable rotary position-sensing system 10 to indicate with a high level of precision when components 12, 14 have certain relative rotary positions. Furthermore, in embodiments where the arrangement of magnets 24, 26, 28 and/or their magnetization directions 34, 36, 38 differs from that shown in FIGS. 1A, 1B, and 3A-3C, the magnetic-flux distribution may vary from the example provided in FIGS. 3A-3C and 4.

A machine 16, 116 may use the signals generated by magnetic-flux sensors 40-42, 40A-42A, 40B-42B of rotary position-sensing systems 10, 10A, 10B for various purposes. Machine 116 may, for example, use the signals generated by magnetic-flux sensors 40A-42A and 40B-42B to perform closed-loop position control. Based on binary signals received from magnetic-flux sensors 40A-42A, controller 124 may determine whether component 12A is disposed in a position where magnet 26A is generally aligned with one of magnetic-flux sensors 40A-42A and, if so, which one. This may indicate to controller 124 one or more aspects of how an operator wants machine 116 to operate.

Based on the information from magnetic-flux sensors 40A-42A, other operator inputs, and/or other information about the operation of machine 116, controller 124 may determine a target rotary position for control component 114 and, thus, a target relative rotary position between components 12B, 14B. In some embodiments, controller 124 may choose the target relative rotary position for components 12B, 14B from a plurality of discrete rotary positions. For example, when choosing the target relative rotary position, controller 124 may choose between a relative rotary position where magnet 26B aligns with magnetic-flux sensor 40B, a relative rotary position where magnet 26B aligns with magnetic-flux sensor 41B, and a relative rotary position where magnet 26B aligns with magnetic-flux sensor 42B.

With a target relative rotary position for components 12B, 14B determined, controller 124 may use information from magnetic-flux sensors 40B-42B to determine whether the actual relative rotary position of components 12B, 14B substantially matches the target relative rotary position. For example, if the target relative rotary position is a position where magnet 26B is aligned with magnetic-flux sensor 41B, controller 124 may use the binary signal from magnetic-flux sensor 41B to determine whether the actual relative rotary position of components 12B, 14B substantially matches that target relative rotary position. If not, controller 124 may operate actuator 122 to rotate component 12B toward the target relative rotary position. In some circumstances, while operating actuator 122 to rotate component 12B toward the target relative rotary position, controller 124 may cause actuator 122 to rotate component 12B through one or more ranges of positions wherein at least one of magnets 24B, 26B, 28B passes at least one of magnetic-flux sensors 40B-42B. Once the signals from magnetic-flux sensors 40B-42B indicate that the actual rotary position between components 12B, 14B substantially matches the target relative rotary position, controller 124 may stop actuator 122.

Methods of operating machine 116 are not limited to the examples provided above. For example, rotation of components 14A, 14B may occur in addition to, or in place of, rotation of components 12A, 12B. Additionally, controller 124 may not use the information from magnetic-flux sensors 40A-42A as a factor in determining the target relative rotary position of components 12B, 14B. Furthermore, rather than selecting the target relative rotary position of components 12B, 14B from a finite set of discrete relative rotary positions, controller 124 may select the target relative rotary position from a continuous range of relative rotary positions.

It will be apparent to those skilled in the art that various modifications and variations can be made in the rotary position-sensing system and methods without departing from the scope of the disclosure. Other embodiments of the disclosed rotary position-sensing system and methods will be apparent to those skilled in the art from consideration of the specification and practice of the motion-control system and methods disclosed herein. It is intended that the specification and examples be considered as exemplary only, with a true scope of the disclosure being indicated by the following claims and their equivalents.

What is claimed is:

1. A machine, comprising:
a first component and a second component between which relative rotation can occur about a rotation axis; and
a rotary position-sensing system, including
a plurality of magnets mounted to the first component, including a first magnet and a second magnet mounted to the first component at different angular positions around the rotation axis, the first magnet being magnetized in a first direction that is at an angle to a circle that extends through the first magnet perpendicular and concentric to the rotation axis, and
a magnetic-flux sensor mounted to the second component to sense magnetic flux generated by at least one of the first magnet and the second magnet and generate a signal.

2. The machine of claim 1, wherein the first direction is substantially parallel to the rotation axis.

3. The machine of claim 1, wherein within a range through which relative rotation between the first component and the second component can occur about the rotation axis, the first magnet and the magnetic-flux sensor pass one another.

4. The machine of claim 1, wherein the rotary position-sensing system generates a signal with a binary value based on the magnitude of the magnetic flux sensed by the magnetic-flux sensor.

5. The machine of claim 1, wherein the second magnet is magnetized in a second direction substantially opposite the first direction.

6. The machine of claim 1, further including a third magnet mounted to the first component on a side of the first magnet opposite the second magnet.

7. The machine of claim 1, wherein the plurality of magnets mounted to the first component are distributed around the rotation axis in a nonuniform manner.

8. The machine of claim 1, wherein:
the rotary position-sensing system is part of a control system of the machine; and
the control system performs closed-loop control of relative rotation between the first component and the second component based at least in part on the signal from the magnetic-flux sensor.

9. The machine of claim 1, wherein the rotary position-sensing system further includes one or more additional magnetic-flux sensors mounted to the second component to sense magnetic flux generated by the first magnet and the second magnet, each of the one or more additional magnetic-flux sensors generating a signal.

10. The machine of claim 9, wherein the rotary position-sensing system is part of a control system of the machine, and the control system controls relative rotation between the first component and the second component, including
selecting a target relative rotary position for the first component and the second component from a plurality of discrete relative rotary positions, each of the discrete relative rotary positions being a position where the first magnet has a particular position with respect to one of the magnetic-flux sensors; and
controlling relative rotation between the first component and the second component based at least in part on the selected target relative rotary position and at least one of the signals generated by the magnetic-flux sensors.

11. The machine of claim 1, wherein:
the rotary position-sensing system is part of a control system of the machine;
the control system further includes an actuator drivingly connected to at least one of the first component and the second component; and
the control system operates the actuator based at least in part on the signal generated by the magnetic-flux sensor.

12. A method of operating a machine having a first component and a second component between which relative rotation may occur about a rotation axis, the method comprising:
generating magnetic flux with a first magnet mounted to the first component;
generating magnetic flux with a second magnet mounted to the first component at a different angular position around the rotation axis than the first magnet;
sensing magnetic flux generated by the first magnet and the second magnet with a magnetic-flux sensor mounted to the second component; and
selectively generating relative rotation between the first component and the second component about the rotation axis, including selectively generating relative rotation between the first component and the second component through a range wherein at least one of the magnets and the magnetic-flux sensor pass one another.

13. The method of claim 12, wherein the first magnet is magnetized in a first direction that intersects the magnetic-flux sensor when the first magnet and the magnetic-flux sensor pass one another during relative rotation between the first component and the second component about the rotation axis.

14. The method of claim 13, further including generating a binary signal based on the density of magnetic flux sensed by the magnetic-flux sensor.

15. The method of claim 12, wherein the first magnet is magnetized in a first direction at an angle to a circle that extends through the first magnet perpendicular and concentric to the rotation axis.

16. The method of claim 15, wherein the second magnet is magnetized in a second direction substantially opposite the first.

17. The method of claim 12, wherein the first magnet is magnetized in a direction substantially parallel to the rotation axis.

18. The method of claim 12, wherein the first and second magnets have a space between them.

19. The method of claim 15, further including performing closed-loop control of relative rotation between the first component and the second component based at least in part on a signal generated by the magnetic-flux sensor.

20. The method of claim 15, further including:
sensing magnetic-flux generated by the first magnet and the second magnet with one or more additional magnetic-flux sensors mounted to the second component; and
selecting a target relative rotary position for the first component and the second component from a plurality of discrete relative rotary positions, each of the discrete relative rotary positions being a position where the first magnet has a particular position with respect to one of the magnetic-flux sensors; and
controlling relative rotation between the first component and the second component based at least in part on the selected target relative rotary position and at least one signal generated by the magnetic-flux sensors.
